(19) United States
(12) Patent Application Publication
(10) Pub. No.: US 2025/0129285 A1
(43) Pub. Date: Apr. 24, 2025

(54) NYLON 66 AS A HIGH TEMPERATURE DIVERTER MATERIAL

(71) Applicant: LyondellBasell Advanced Polymers Inc., Houston, TX (US)

(72) Inventor: Bradley L. Todd, Duncan, OK (US)

(73) Assignee: LyondellBasell Advanced Polymers Inc., Houston, TX (US)

(21) Appl. No.: 18/919,646

(22) Filed: Oct. 18, 2024

Related U.S. Application Data
(60) Provisional application No. 63/545,088, filed on Oct. 20, 2023.

(51) Int. Cl. C09K 8/508; C09K 8/72; E21B 33/138; E21B 37/06; E21B 43/26

(52) U.S. Cl. CPC C09K 8/5086; C09K 8/72; E21B 33/138; E21B 37/06; E21B 43/261

(57) ABSTRACT

The disclosure provides a composition containing nylon 66 used in treatment fluids during well stimulation methods for application in reservoirs with very high temperatures. Methods for the application of nylon 66 in treatment fluid as a diverting and bridging agent for high temperature reservoirs are also discussed.

### PRIOR RELATED APPLICATIONS

This application claims the benefit of priority to U.S. Provisional Application No. 63/545,088, filed on Oct. 20, 2023, which is incorporated here by reference in its entirety.

### FEDERALLY SPONSORED RESEARCH STATEMENT

Not applicable.

### FIELD OF THE DISCLOSURE

The disclosure generally relates to polymers that can be used for reservoir in very high temperature reservoirs.

### BACKGROUND OF THE DISCLOSURE

With the rising demands in oil and gas, and challenges associated with achieving maximum production from a reservoir, well stimulation treatments (WST) are gaining importance to enhance the recovery of oil and gas from a reservoir. Both mechanical and chemical methods for stimulation of a well are used, depending on the reservoir properties. Mechanical stimulation methods include ‘hydraulic fracturing’, and chemical methods include ‘acidizing’ the well.

Hydraulic fracturing involves pumping large volumes of fluid into the formation at pressure beyond the fracture pressure—the pressure at which rocks break. This causes the rock to crack and once fractured, sand or other proppants are then pumped into the reservoir, to “prop” the fractures open and thereby provide a flow path for the production of hydrocarbon. During ‘acidizing’ of a well, matrix rock or areas with natural or hydraulic fractures that may have clogged over the years can be stimulated by the injection of acids to dissolve clogs and reform the channels for the flow of oil and gas. Acids are also used to enlarge fractures in carbonate reservoirs.

Diverting agents may also be used during a well stimulation to control where the fluid preferentially flows. By pumping in a temporary diverting agent, fluid distribution can be altered, to redirect the next treatment to new areas of the reservoir. Diverting agents may also be used to block “thief zones”—regions of high permeability that tend to allow a treatment fluid to leak off or drain away from where it is needed. Once the treatment is completed, the diverting agent degrades, and the degraded material flows back to the surface with the flow-back liquid containing crude oil and gas, water, sand and other treatment fluids.

The working principles of diverting agents in reservoir treatment are illustrated in FIG. 1 (from Zhao (2020)), wherein diverting agents block flow and redirect fluid elsewhere. In FIG. 1a, numbers represent the order in which fractures appear. The smaller the number, the earlier the fractures appear. Inter-layer diverting occurs in the different layers, while intra-layer diverting occurs in the same layer. In FIG. 1b, the arrows mean the acid flow direction, and the length of arrows in the low permeability area mean acid quantity.

A common mechanism of degrading a diverting agent is by hydrolysis, although breaker agents can also be used with some polymers. With hydrolysis, controlling the decomposition of diverting agents at either low or high reservoir temperatures can be challenging. The rate of hydrolysis is slowed at low temperatures, making the degradation unpredictable and possibly too slow. By contrast, at high temperatures the degradation is often too fast, not providing an operator sufficient time to complete the next treatment before the diverting agent degrades. Thus, in treating high temperature reservoirs, the operator may first pump cool fluids downhole to slow the rate of hydrolysis of subsequently pumped diverting agents. However, the use of fluids to precool the reservoir adds to time and cost, and is less desirable where oils are already too viscous to pump.

Thus, what is needed in the art are new polymers that degrade under high temperature reservoir conditions, but have a reasonable lifespan before degrading, preferably degrading with no harmful residue and lasting long enough to accomplish the treatment goals. The ideal material and methods would also be cost effective, not harm the reservoir, nor harm any equipment at the production facility, not produce harmful or undesirable byproducts, would be easy to apply, reliable, low cost and have high efficiency. Such a polymer could have a wide variety of applications in a reservoir, in addition to being suitable as a diverting agent. This invention addresses one or more of these needs.

### SUMMARY OF THE DISCLOSURE

Described herein are polymer compositions for various treatment fluids, and methods of their use in high temperature reservoirs, including for example, hydrocarbon and water production reservoirs, geothermal formations, and for water injection wells. The compositions includes the use of the heat-stable polyamides, such as polymer nylon 66 in a solvent package for use in a variety of applications, such as use as a diverting agent, a bridging agent, to block thief zones, in stimulation treatments, such as fracking or acidizing, in fluid loss control, in lost circulation, plugging operations, such a plugging perforations, tool ports, wellbores, tubing or screens, or building a filtercake on permeable media, or anywhere where it is desired to temporarily block flow paths and later reopen them.

These degradable polymers may also be used as a coating to temporarily protect a coated object until needed. Such objects may be screens or tools, such as temporary plugs, or other treatment chemicals where it is desired to delay the activity of that chemical.

Nylon 66 (also referred to as PA66) is a an exemplary heat-stable polyamide (PA) based polymer with a formula (C₁₂H₂₂N₂O₂)ₙ. It is made of two monomers, each containing 6 carbon atoms-hexamethylenediamine and adipic acid-which gives nylon 66 or PA66 its name. EQ. 1 below shows the reaction needed to make nylon 66. Among other favorable properties, the stability of nylon 66 at high temperatures makes it suitable for functioning in high temperature oil and gas reservoirs.

Equation 1. Synthesis of Nylon 66 using hexamethylene diamine and adipic acid.

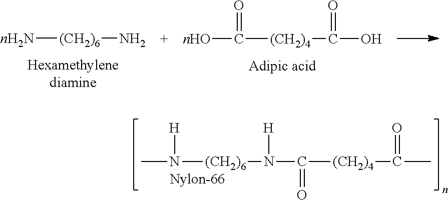

Nylon 66 has a very high melting point of at least 490° F., alternatively at least 495° F., and up to 507° F. (264° C.), and good stability at high temperatures, but until now has not been used in reservoirs as a temporary plugging or diverting agent. For use as a plugging or diverting agent, nylon 66 can be used as is, without any coating, capping or further gelling agents, thus reducing cost in the preparation and application of this polymer of agent. As used herein, the term “plugging” refers to means for preventing the flow of hydrocarbons or fluid from an interior portion of a subterranean formation to an exterior portion of a subterranean formation or to the surface. As described herein, any heat stable polyamide may be used, provided that said heat stable polyamide has a melting point of at least 400° F., alternatively at least 425° F., alternatively at least 450° F., and in other embodiments, at least 475° F.

In methods of plugging or diverting flow in a reservoir, the compositions disclosed herein are injected into the reservoir, thereby plugging pores and/or fissures in the reservoir or in a portion of the reservoir. Once blocked, the operator can perform any intermediate treatments or well operations. These operations can be performed on portions of the formation that are not blocked. In certain embodiments, the steps of injecting the compositions and treating the formation and well described herein can be repeated multiple times before the nylon 66 is either allowed to degrade or intentionally degraded. Eventually, the polymer will hydrolyze under reservoir conditions and the remnants can eventually pumped out along with the flow back fluids.

Generally speaking, when used for plugging or diverting flow the composition comprises nylon 66 particles prepared in a carrier fluid. Nylon 66 as can be used in low temperature reservoir temperatures of about 100-250° F., but its best applications are in high temperature reservoirs of about 250-700° F., or at temperatures of greater than 350° F., or more preferred about 300-500° F., or about 350-500° F. When used in reservoirs wherein the temperature is less than 300° F., or even less than 350° F., heated water, acids or acidified water may be used to degrade and remove the Nylon 66 from the reservoir. Exemplary acids can include formic, acetic or other weak acids. In formations having temperatures of greater than 450° F., it may be advantageous to cool the plugging fluid prior to injecting into the formation. In alternate embodiments wherein formations have temperatures of greater than 450° F., it may be advantageous to cool the formation by injecting a cooled fluid prior to injecting the plugging fluid into the formation.

In some embodiments, treatment fluids containing a heat-stable polyamide, such as nylon 66, can be used to seal off a portion of the subterranean formation at elevated temperatures without the addition of any cooling fluids since nylon 66 has a reasonable half-life at high temperatures. In other instances, a reduced volume of cooling fluid can be used than would normally be used with less stable polymers, such as polylactic acid or polyglycolic acid based polymers. Thus, in certain embodiments wherein the formation is at a temperature of 350° F. or greater, a first step of treating the formation may include the step of providing cooling means to the formation to reduce the average temperature of the formation to be treated, and then supplying the treatment fluids containing a heat-stable polyamide, such as nylon 66. The formation can either be continually cooled during the time in which the formation undergoes some form of secondary treatment or operation, or it can be allowed to gradually return to the higher temperature, depending on the needs of the operator. Similarly, in a formation having an average temperature of less than about 350° F., the treatment fluids can be supplied to the formation and after the secondary treatment or operation, the process may further include a step wherein heated fluids or steam are injected to raise the temperature of the formation to a temperature sufficient to degrade the nylon 66.

Nylon 66 is a versatile polymer and can be ground, crushed or otherwise comminuted to the desired particle size for application as a diverting agent and if needed sieved for particle uniformity. In general, depending upon the desired application and formation characteristics, particles ranging from approximately 5 micron up to approximately 10 mm may be used. In certain embodiments, particle size distributions of around 10-20 mesh are preferred, thus 10-20 mesh (about 2000-840 microns) are typically used, however, nylon 66 can be prepared for mesh size of about 20-40 (particle size of around 840 to 420 microns), and mesh size of about 30-60 (particle size of about 595-250 microns). In some embodiments, smaller particle sizes of mesh size of about 70-80 (particle size of about 210 to 177 microns) are used. In certain embodiments, the particle size distribution is between 300 and 1200 microns, alternatively between 300 and 700 microns, alternatively between 600 and 1200 microns. A skilled operator knows how to vary the size of a particle to optimize its effect of the treatment. For example, larger particles will only penetrate fractures that are large enough to permit their entry, leaving the subsequent treatments to preferentially target smaller fractures. Likewise, much larger particles may be used to target certain thief zones. Different sizes of particles can also be used sequentially to target different zones, at particle sizes optionally ranging from submicron up to about 1-2 inches in diameter; depending on the application.

Typically, the treatment solution will contain up to about 20 wt. % of the polyamide material. Thus, in certain embodiments, 0.1-20 wt. % of nylon 66 in an aqueous treatment fluid can be used. In some embodiments, 0.5-10 wt. % of nylon 66 in an aqueous treatment fluid can be used. A treatment fluid comprising Nylon 66 wt. % of about 1-5%, alternatively from about 1-2.5%, alternatively from about 3-10%, alternatively from about 3-7.5%, alternatively between 5 and 15%, alternatively between 10 and 15%, may also be used in some other embodiments.

Once the plugging fluid is injected into the formation to plug the first portion of the formation, the flow of fluids from said first portion of the formation may be reduced by at least 70%, alternatively at lease 75%, alternatively at least 80%, alternatively at least 85%, alternatively at least 90%, alternatively at least 95%, and in certain embodiments, by at least 98%.

In some examples, variants and close alternatives to nylon 66 can be used in place of or in addition to PA66. These may include polyamides like nylon 6, PA69, PA6-10, PA6-12, and PA 46. Other variants may include bio-based polyamides like EcoPaXX®, polybutylene terephthalate (PBT) polymers, such as commercially available Arnite® PBT, polyphthalamide (PPA) based polymers, etc. may also be used. In general, any polyamide having a relatively high degradation temperature and water soluble degradation products can be used for these applications. In various embodiments, these variant polymers can be prepared in aqueous based carrier fluids and crushed, ground or sieved to desired particle size. However, the stability, availability, and cost of nylon 66 make it attractive to be the predominant polymer used for applications as a temporary blocking agent in treatment fluids.

In certain embodiments, it is also possible to combine nylon 66 with other polymers to effect the overall properties of the polymeric blend. For example, one may combine nylon 66 with polymers that are less stable at high temperatures, or even with polymers having a higher temperature stability. By controlling the ratios of these polymers, it will be possible to better control the degradation time as needed for the application at issue, as well as potentially impacting other aspects of the treatment.

The carrier fluid used to prepare the nylon 66 composition may be varied according to the application and also the reservoir characteristics. In typical laboratory experiments relating to the testing of polyamide degredation, water is used as the carrier fluid, however for downhole field applications, a brine-water mixture, or a viscosified water-brine mixture, or an oil-based mud containing an aqueous component can be used. In certain embodiments, the carrier fluid may comprise up to 10% brine, alternatively up to 20% brine, or alternatively up to 30% brine. The carrier fluid may thus contain brine, seawater, produced water, foamed fluids, or an emulsion.

The carrier fluid may include additives such as salts, viscosifying agents, pH control additives, surfactants, breakers, biocides, crosslinkers, additional fluid loss control agents, filtration aids, stabilizers, chelating agents, scale inhibitors, gases, solvents, mutual solvents, particulates, corrosion inhibitors, oxidizers, enzymes, reducers, friction reducers, and any combination thereof.

In some embodiments, pH control agents in the form of acid/base buffers or salts are also added in order to selectively increase or decrease the degradation rate of nylon 66 at elevated temperatures. One of ordinary skill in the art will be able to decide and recognize various reagents and chemicals that can be added to the treatment fluid for desired activities and degradation rate.

In certain embodiments, the nylon 66 particles may be coated with materials that may reduce swelling of the particles or prolong degradation at higher temperatures. The nylon 66 particles may be coated by known methods, including solvent evaporation, wrapping with film, or melt dip coating.

In a first embodiment, a method of temporally plugging a portion of a subterranean formation having a temperature of at least 300° F. is provided. The method includes the steps of injecting a plugging fluid comprising polyamide 66 (PA66) and a carrier fluid into said formation, thereby plugging a first portion of said formation with said fluid; treating an unplugged portion of said formation with a second fluid; allowing said PA66 to degrade over a period of time, thereby unplugging said first portion of said formation; and performing an additional operation on formation. The formation can be selected from a hydrocarbon formation, a geothermal formation, a water production formation, or a water injection formation. In one embodiment, the subterranean formation can be a hydrocarbon formation and the additional operation may be the step of producing hydrocarbon, said carrier fluid, said second fluid and said degraded PA66 from the formation. In certain embodiments, the step of performing an additional well operation can include treating the unplugged portion of the formation with a secondary fluid. The carrier fluid can include water or brine. In certain embodiments, the nylon 66 has an average particle size of about 1200 microns, alternatively about 820 microns or alternatively about 420 microns. In certain embodiments the nylon 66 has an average particle size of between 300 and 1200 microns. In alternate embodiments, the nylon 66 has an average particle size of between 300 and 700 microns and in other embodiments, the nylon 66 has an average particle size of between 600 and 1200 microns. In certain embodiments, the formation temperature is about 350° F. and said period of time for the degradation is at least about 40 days.

In alternate embodiments, wherein the formation temperature is about 400° F. and said period of time is at least about 2 days. The carrier fluid may further include at least one additive selected from a group consisting of surfactants, breakers, biocides, corrosion inhibitor, paraffin inhibitor, pH control additives, stabilizers, scale inhibitors, friction reducers, viscosifiers, and combinations thereof. The second treatment fluid can be selected from a hydraulic fracturing fluid, an acidizing fluid, or a water drive fluid. When the second treatment fluid is an acidizing fluid, it can be selected form formic or acetic acid.

In another embodiment, an improved method of diverting fluids in a high temperature reservoir, wherein the method includes injecting a cooling fluid into a high temperature reservoir to precool said reservoir (wherein the high temperature reservoir temperature is at least 375° F., and in some instances at least 400° F.), and then injecting a diverting fluid comprising a polymer to block a portion of said precooled reservoir, the improved method includes the steps of injecting a diverting fluid comprising a heat resistant polyamide, for example nylon 66, into a high temperature reservoir, wherein in certain embodiments less cooling fluid is required to precool said reservoir or in certain embodiments, no cooling fluid is required to precool the reservoir.

In another embodiment, a method of treating a subterranean hydrocarbon formation, said method comprising the steps of: (a) injecting a fluid that includes nylon 66 particles and an aqueous carrier fluid into a formation, thereby blocking a portion of said formation with the nylon 66 particles; (b) treating a remaining unblocked portion of the formation with a treatment fluid; (c) allowing said nylon 66 particles to degrade for a period of time of at least 2 days at a formation temperature of at least 400° F.; and (d) producing hydrocarbon, said carrier fluid, said treatment fluid and said degraded nylon 66 particles. In certain embodiments, steps (a) and (b) can be repeated multiple times before the nylon 66 particles are allowed to degrade. In certain embodiments, the treatment fluid is selected from a hydraulic fracturing fluid, an acidizing fluid, a water drive fluid, and a steam drive fluid. The carrier fluid can include at least one additive selected from a group consisting of surfactants, breakers, biocides, corrosion inhibitor, paraffin inhibitor, pH control additives, stabilizers, scale inhibitors, friction reducers, viscosifiers, and combinations thereof.

In another embodiments, a composition for use in hydrocarbon reservoir for well stimulation is provided, the composition including: polyamide particles having a distribution size range within 20 mesh and an aqueous carrier fluid, wherein the composition remains stable for at least 2 days at a reservoir temperature of 400° F. In certain embodiments, the polyamide particles have a melt temperature of at least 500° F. In certain embodiments, the composition further includes at least one additive selected from a group consisting of surfactants, breakers, biocides, corrosion inhibitor, paraffin inhibitor, pH control additives, stabilizers, scale inhibitors, friction reducers, viscosifiers, and combinations thereof.

In one aspect, the present invention provides a method of plugging a subterranean formation, the method comprising the steps of: a) injecting a plugging fluid comprising polyamide 66 (PA66) and a carrier fluid into the formation, thereby creating a plugged first portion of said formation and an unplugged second portion of the formation; b) treating the unplugged second portion of said formation with a second fluid; and c) allowing said PA66 to degrade over a period of time, thereby unplugging said first portion of said formation. The method can further include the a step wherein following treating the unplugged second portion of the formation, a heated fluid at a temperature of greater than 350° F. is injected, said heated fluid thereby causing the PA66 to degrade more quickly. In alternate embodiments, the fluid that is injected is heated to a temperature of greater than 400° F. In certain embodiments, the step of performing an additional well operation can include treating the unplugged portion of the formation with a secondary fluid.

In certain embodiments, the carrier fluid can include water or brine. In some embodiments, the PA66 has an average particle size of between about 300 and 1200 microns. Alternatively, the PA66 has an average particle size of between 300 and 700 microns. In yet other embodiments, the PA66 has an average particle size of between 600 and 1200 microns. In certain embodiments, the PA66 has a melting point of at least 490° F. In certain embodiments, the plugging fluid includes between 0.5 and 10% by weight of the PA66 in the carrier fluid. In other embodiments, the plugging fluid comprises between 2 and 8% by weight of the PA66 in the carrier fluid.

The carrier fluid can also include at least one additive selected from a group consisting of surfactants, breakers, biocides, corrosion inhibitor, paraffin inhibitor, pH control additives, stabilizers, scale inhibitors, friction reducers, viscosifiers, and combinations thereof. In certain cases, thee second treatment fluid is selected from a hydraulic fracturing fluid, an acidizing fluid, or a water drive fluid. More specifically, in certain instances, the acidizing fluid may be formic or acetic acid.

In certain embodiments, the subterranean formation include a hydrocarbon formation and following degradation of the PA66, the method can further include the steps of producing hydrocarbon, the carrier fluid, the second fluid and the degraded PA66 from the formation. In certain embodiments, the step of creating a plugged first portion of said formation results in a decrease in the flow of fluids from the first portion of the formation of at least 80% of the original flow before the plugging step. Alternatively, in certain instances, the step of creating a plugged first portion of said formation results in a decrease in the flow of fluids from the first portion of the formation of at least 90% of the original flow before the plugging step. In yet other embodiments, the method steps (a) and (b) can be repeated multiple times before the PA66 particles are allowed to degrade.

As used herein, ‘hydraulic fracturing’ is a well stimulation technique in which fluids, typically containing water and other treatment fluids are injected into a reservoir under pressure to create formation fractures via which oil and gas can be extracted.

As used herein ‘acid stimulation’ or ‘acid treatment’ refers to well stimulation technique in which acid treatment fluids are injected into a reservoir to dissolve minerals in the formation creating a flow path for oil and gas for extraction. Acid treatments are typically performed in reservoirs containing carbonate rocks.

As used herein ‘carrier fluid’ or ‘base fluid’ are used interchangeably and refer to fluid that is used to transport materials into and out of a wellbore. They are chosen for their ability to efficiently transport chemicals required for hydraulic fracturing or acid treatment and the like, ability to separate and release materials as the application requires and compatibility with other wellbore fluids so as to not cause any formation damage. Water, water with brine, water with oil based mud, water with varying amounts of organic solvents like glycol, kerosene, etc. are usually used as carrier fluids.

By contrast, the ‘treatment fluid’ is the entire package, including the carrier fluid, nylon 66 and any desired additives.

As used herein, ‘diverting agents’ or ‘diverting material’ or ‘diverting chemicals’ are chemicals added to treatment fluids and are used to distribute the treatment fluids from high permeability zone to low permeability zone in a formation by blocking certain pores and/or fractures for a period of time. These agents degrade over time under reservoir conditions and are recovered in flow back fluids.

As used herein ‘flowback’ or ‘flowback fluids’ refer to fluids that are produced during the production of oil and gas that is returned via a production well from the formation and generally contain hydraulic fluids, produced water, degraded injection chemicals, and the like, along with oil and gas.

All concentrations used herein are in weight percent (wt. %), unless otherwise specified. Particle size is described in US standard sieve mesh size, and microns.

The use of the word “a” or “an” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim. The phrase “consisting of” is closed and excludes all additional elements. The phrase “consisting essentially of” excludes additional material elements, but allows the inclusions of non-material elements that do not substantially change the nature of the invention, such as instructions for use, buffers, and the like. Any claim or claim element introduced with the open transition term “comprising,” may also be narrowed to use the phrases “consisting essentially of” or “consisting of,” and vice versa. However, the entirety of claim language is not repeated verbatim in the interest of brevity herein.

The following abbreviations are used herein:

TABLE 1
Abbreviations

| ABBREVIATION | TERM |
|---|---|
| WST | Well stimulation technologies |
| PBT | Polybutylene terephthalate |
| PET | Polyethylene terephthalate |
| PA | Polyamide |
| PAM | Polyacrylamide |
| PPA | Polyphthalamide |
| PA66 | Polyamide 66, aka nylon 66 |

### BRIEF DESCRIPTION OF THE DRAWINGS

FIG. 1. Diverting agent mechanism in the formation.

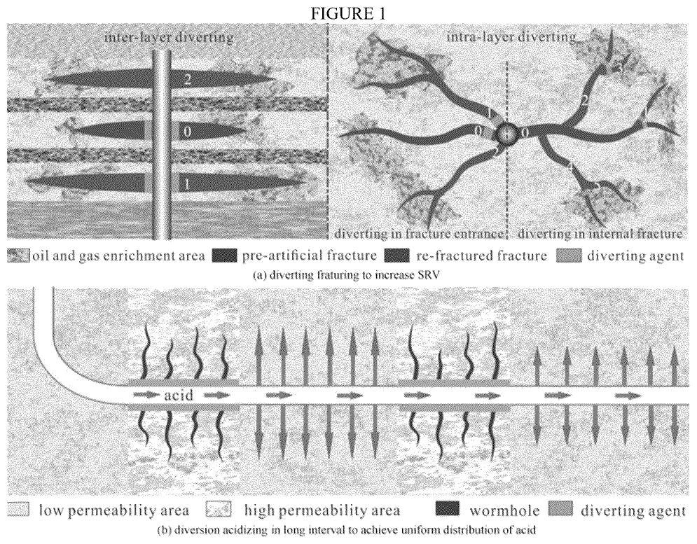

FIG. 2. Degradation of Nylon 66 versus time at 350° F. in water.

FIG. 3. Degradation of Nylon 66 versus time at 400° F. in water.

### DETAILED DESCRIPTION

Degradation of nylon 66 in aqueous solution was measured as a function of time. The nylon 66 tested was Vydyne® 50BW. It's characteristics are found in Table 2 below.

TABLE 2
Nylon 66

| Property | Value | Test Method |
|---|---|---|
| Density | 1140 | ISO 1183 |
| Melt temp. | 260° C. | ISO 11357-3 |

For this example, 16 sealable glass jars containing 1 g of finely powdered nylon 66 dissolved in 100 mL of tap water were prepared. The particle size of the nylon 66 polymer for this example was approximately 420 microns. The glass jars were sealed and placed in a temperature-controlled oven. Sealed jars 1-10 were set at 350° F. (176° C.) and jars 11-16 were set at 400° F. (204° C.). At predetermined times, one jar was removed from the oven, and the remaining polymer in the jar was filtered, dried and weighed to determine the change in weight over time. In an alternate experiment, nylon 66 beads having a diameter of 2.5 mm and 300 micron were compared, demonstrating similar performance between the particles.

Jars 1-10 were initially removed at 24 h (1 day) and 36 h (1.5 days) but the change in polymer % remaining was insignificant. Therefore, the jars were removed at longer intervals of time at 10 days, 15 days, 20 days, 25 days, 30 days, 35 days and 40 days, and finally at 42 days. The solid sample was filtered, dried then weighed. Fluid and solids were then recombined in the appropriate jar and placed back at temperature.

Jars 11-16 were initially removed at 6 h, 12 h (0.5 days) and 24 h (1 day). The change in polymer % remaining decreased considerably compared to that at 350° F. Therefore, the jars were removed at shorter interval of time for the jars kept at 400° F. The jars were removed after 36 h (1.5 days), 48 h (2 days) and 60 h (2.5 days).

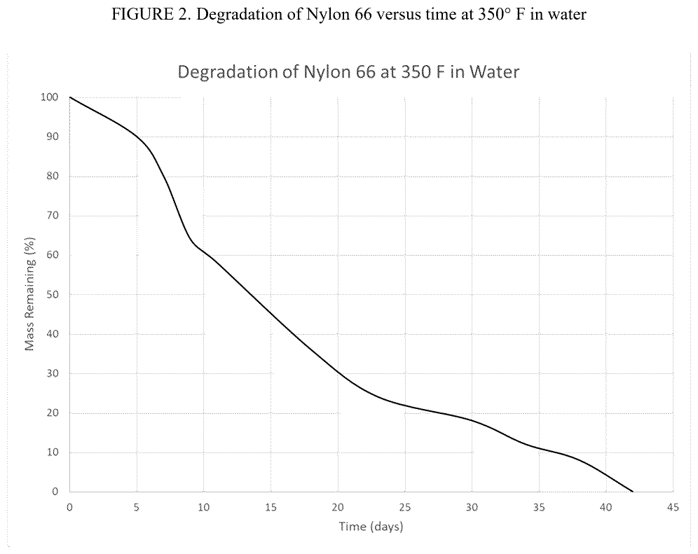

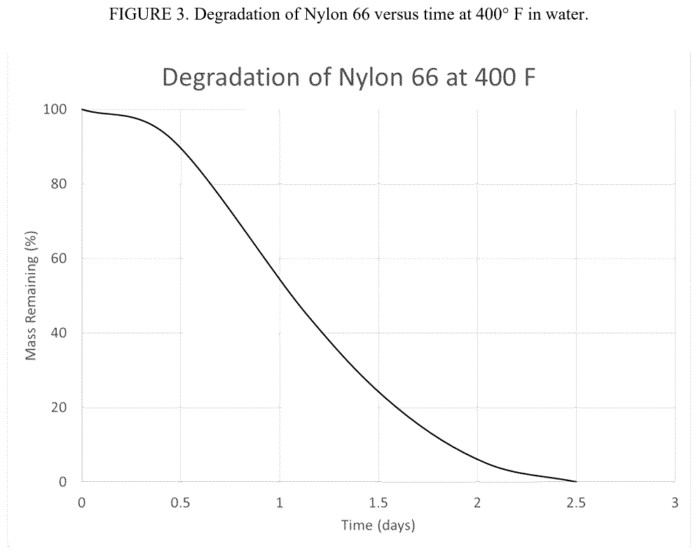

Polymer degradation results at 350° F. and at 400° F. are shown in are shown in FIG. 2 and FIG. 3, respectively.

FIG. 2 presents degradation curve for nylon 66 water at 350° F. The degradation profile charts % of polymer remaining in solution as a function of time (in days). Nylon 66 degrades slowly at 350° F., and the degradation is only 10% complete within the first 5 days. There is a slight increase in rate of degradation between 5-10 days and then there is a steady degradation of polymer till all the polymer is degraded at 42 days.

FIG. 3 shows degradation curve for nylon 66 water at even higher temperature of 400° F. Unlike at 350° F., the degradation reaction is quicker, and a complete degradation is observed within 2.5 days. The polymer degrades at a steady rate at this temperature.

Degradation result at 10%, 50% and complete (100%) degradation of results are presented in Table 3.

TABLE 3
Experimental Set-up for High Temperature
Degradation of Nylon 66

| | | 10% | 50% | Complete |
|---|---|---|---|---|
| Jar | Temperature | Polymer | Polymer | Polymer |
| No. | of oven | Degradation | Degradation | Degradation |
| 1-10 | 350° F. | 5 days | 14 days | 42 days |
| 11-16 | 400° F. | 0.5 days | 1 day | 2.5 days |

Nylon 66 was stable for many days and did not significantly degrade at 350° F. In fact, only 10% of the polymer was degraded after 5 days at 350° F. A total of 42 days were required for complete degradation of the polymer. At even higher temperature of 400° F., nylon 66 was found to degrade completely after 2.5 days. This is a significant improvement over diverting agents that degrade within hours of application at even lesser temperatures. This shows that nylon 66 can be used as diverting agents in applications where the reservoir temperatures is very high.

The examples herein are intended to be illustrative only, and not unduly limit the scope of the appended claims. Although the present disclosure and its advantages have been described in detail, it should be understood that various changes, substitutions and alterations can be made herein without departing from the scope of the disclosure as defined in the claims.

The following references are incorporated by reference in their entirety for all purposes:
U.S. Pat. No. 11,326,088 Low temperature diversion in well completion operations using natural mineral compound.
US20210032527 Weighted fluid loss control pill for completion & workover operations.
US20210403800 Anti-caking or blocking agent for treating solid acid precursor additives used in treating subterranean formations.
HARRISON, N. W. Diverting agents-history and application. Journal of Petroleum Technology, 1972, pp 593-598.
ZHAO, L.; et al. A review of diverting agents for reservoir stimulation. Journal of Petroleum Science and Engineering, 187, 2020, 106734

1. A method of plugging a subterranean formation comprising:
a) injecting a plugging fluid comprising polyamide 66 (PA66) and a carrier fluid into the formation, thereby creating a plugged first portion of said formation and an unplugged second portion of the formation;
b) treating the unplugged second portion of said formation with a second fluid; and
c) allowing said PA66 to degrade over a period of time, thereby unplugging said first portion of said formation.

2. The method of claim 1, wherein step (c) includes the step of injecting a fluid heated to a temperature of greater than 350° F., said heated fluid thereby causing the PA66 to degrade more quickly.

3. The method of claim 1, where wherein step (c) includes the step of injecting a fluid heated to a temperature of greater than 400° F., said heated fluid thereby causing the PA66 to degrade more quickly.

4. The method of claim 1 wherein the step of performing an additional well operation comprises treating the unplugged portion of the formation with a secondary fluid.

5. The method of claim 1, wherein said carrier fluid comprises water or brine.

6. The method of claim 1, wherein PA66 has an average particle size of between about 300 and 1200 microns.

7. The method of claim 1, wherein the PA66 has an average particle size of between 300 and 700 microns.

8. The method of claim 1, wherein the PA66 has an average particle size of between 600 and 1200 microns.

9. The method of claim 1, wherein said carrier fluid further comprises at least one additive selected from a group consisting of surfactants, breakers, biocides, corrosion inhibitor, paraffin inhibitor, pH control additives, stabilizers, scale inhibitors, friction reducers, viscosifiers, and combinations thereof.

10. The method of claim 1, wherein said second treatment fluid is selected from a hydraulic fracturing fluid, an acidizing fluid, or a water drive fluid.

11. The method of claim 10, wherein the acidizing fluid is selected from formic or acetic acid.

12. The method of claim 1 wherein the subterranean formation comprises a hydrocarbon formation and following degradation of the PA66, the method further comprises producing hydrocarbon, said carrier fluid, said second fluid and said degraded PA66 from the formation.

13. The method of claim 1, wherein the PA66 has a melting point of at least 490° F.

14. The method of claim 1, wherein the step of creating a plugged first portion of said formation results in a decrease in the flow of fluids from the first portion of the formation of at least 90% of the original flow before the plugging step.

15. The method of claim 1, wherein the step of creating a plugged first portion of said formation results in a decrease in the flow of fluids from the first portion of the formation of at least 80% of the original flow before the plugging step.

16. The method of claim 1 wherein steps (a) and (b) are repeated multiple times before the PA66 particles are allowed to degrade.

17. The method of claim 1, wherein said plugging fluid comprises between 0.5 and 10% by weight of the PA66 in the carrier fluid.

18. The method of claim 1 wherein said plugging fluid comprises between 2 and 8% by weight of the PA66 in the carrier fluid.
